(19) United States
(12) Patent Application Publication
(10) Pub. No.: US 2023/0291001 A1
(43) Pub. Date: Sep. 14, 2023

(54) SOLID-STATE CONDUCTOR MATERIALS

(71) Applicant: THE UNIVERSITY OF LIVERPOOL, Merseyside (GB)

(72) Inventors: Alexandra MORSCHER, Liverpool (GB); Matthew DYER, Liverpool (GB); Matthew ROSSEINSKY, Liverpool (GB)

(21) Appl. No.: 17/999,586

(22) PCT Filed: May 21, 2021
(86) PCT No.: PCT/GB2021/051249

§ 371 Date: Nov. 22, 2022

(30) Foreign Application Priority Data
May 22, 2020 (GB) 2007661.8

(51) Int. Cl. H01M 10/0562; H01M 10/0525

(52) U.S. Cl. CPC H01M 10/0562; H01M 10/0525; H01M 2300/008

(57) ABSTRACT

A solid crystalline material of formula (I): AzDY4Xx, wherein each A is independently selected from Li, Na, K and Mg; D is selected from Si, Al, P, B, Ga, Ge, S, Mo, W, V, Sn, Sb, Nb and Ta, or a mixture thereof; each Y is independently selected from O, S, F, Cl, Br or a mixture thereof; each X is independently selected from F, Cl, Br, I, O, S, BH4 or a mixture thereof; z is from 2 to 8; and x is from 1 to 3. The solid crystalline material suitably provides a solid ionic conductor for use in a solid-state battery. A mixed solid crystalline material comprising the solid crystalline material, a solid-state battery comprising the solid crystalline material and a method of preparing the solid crystalline are also disclosed.

### FIELD

The present invention relates to a solid crystalline material, a method of preparing a solid crystalline material and the use of a solid crystalline material as a solid ionic conductor. In particular, the present invention relates to a new class of solid crystalline materials which may find utility as solid ionic conductors, for example as solid electrolytes in solid-state lithium ion batteries.

### BACKGROUND

Lithium ion batteries comprise an anode, a non-aqueous electrolyte, a separator and a cathode. Organic electrolytes (primarily based on linear and cyclic alkyl carbonates) are typically used because of the wide operating voltage they provide. However, such organic electrolytes have high volatility and flammability, posing a serious safety issue for their use in the consumer and transportation markets. When exposed to extreme conditions (such as elevated voltage and temperature), organic liquid electrolytes can react with the active electrode materials to release significant heat and gas, leading to fires and possibly explosions. There is therefore a need to provide safer, alternative electrolytes with comparable or superior ion conduction.

Recent advances in lithium ion battery technology have involved the use of solid electrolytes provided by inorganic solid ion conductors, as replacements for organic liquid electrolytes. These inorganic solid ion conductors conduct electricity by the passage of ions through an otherwise rigid crystal structure. Usually, only one type of ion (either cations or anions) is predominantly mobile and conducts electricity in the solid. Ionic conductors are therefore potentially useful in batteries, sensors and solid oxide fuel cells.

Achieving conductivities in such solid electrolytes which are comparable to those of existing liquid electrolytes remains a challenge due to the reduced mobility of the ions. One approach to achieve a desirable conductivity is based on doping various elements into the crystal structure of the solid ion conductor, for example to produce oxide and sulfide structures. However, this often results in sub-optimal physical properties of the solid electrolyte which hinders processing of the material in the manufacture of batteries. Some current lithium ion conducting solid electrolytes have low ionic conductivity and high elastic constants which hinder processing (e.g. Li₇La₃Zr₂O₁₂, Li_{1.3}Al_{0.3}Ti_{1.7}(PO₄)₃), whilst others have poor stability and low elastic constants (e.g. Li₆PS₅I and Li₁₀P₂GeS₁₂) which hinders performance.

### SUMMARY OF THE INVENTION

The lithium-containing argyrodites are a family of lithium ion conductors with potential application in solid-state batteries. Materials such as Li₆PS₅Br have sufficient ionic mobility for such applications. However, their stability in air and against metallic lithium are a concern, and their soft mechanic properties make processing the materials challenging. Replacing the sulfide ion with the oxide ion in Li₆PO₅Cl and Li₆PO₅Br has the potential to improve stability and mechanical properties but has a concurrent drop in ionic conductivity to values below useful levels.

It is one aim of the present invention, amongst others, to provide a solid crystalline material that addresses at least one disadvantage of the prior art, whether identified here or elsewhere, or to provide an alternative to existing solid crystalline materials. For instance, it may be an aim of the present invention to provide a solid crystalline material which can be used a solid ionic conductor for use in lithium ion batteries.

According to aspects of the present invention, there is provided a solid crystalline material, a battery comprising such a solid crystalline material, a method of preparing such a solid crystalline material and use of the solid crystalline material as set forth in the appended claims. Other features of the invention will be apparent from the dependent claims, and from the description which follows.

According to a first aspect of the present invention, there is provided a solid crystalline material of formula (I): A_{z}DY₄Xₓ wherein:
each A is independently selected from Li, Na, K and Mg;
D is selected from Si, Al, P, B, Ga, Ge, S, Mo, W, V, Sn, Sb, Nb and Ta, or a mixture thereof;
each Y is independently selected from O, S, F, Cl, Br or a mixture thereof;
each X is independently selected from F, Cl, Br, I, S, O, BH₄ or a mixture thereof;
z is from 2 to 8; and
x is from 1 to 3.

Each of the A, D, Y and X atoms can be present in mixtures of atoms selected from the lists and therefore are not necessary present in stoichiometric amounts, i.e. z and x are not necessarily integers and DY₄ may be a mixture of different DY₄ species, within the above lists of options.

The solid crystalline material of this first aspect suitably comprises a highly ordered microscopic structure forming a crystal lattice extending in three dimensions. The solid crystalline material is suitably formed from a unit cell which repeats in three dimensions to form a three-dimensional lattice structure. As will be known by the skilled person, a unit cell is characterized by six parameters. These parameters are three edges (a, b and c) and angles between them (α, β and γ). Suitably, using these parameters, a unit cell may be defined as cubic, tetragonal, orthorhombic, monoclinic, hexagonal or triclinic.

Suitably the solid crystalline material of this first aspect comprises a hexagonal unit cell and/or an orthorhombic unit cell. The solid crystalline material of the first aspect may be defined by a hexagonal unit cell and/or an orthorhombic unit cell.

The solid crystalline material of the first aspect may be based on a mixture of cubic and hexagonal stacking of constituent layers. As will be understood by the skilled person, the structure may be described using a hexagonal unit cell as the basic structural motif. Minor displacements and ion orderings may change the unit cell and symmetry such that the crystal structure of the solid crystalline material may be described as a derivative of a hexagonal unit cell. Suitably the solid crystalline material may be described by a lower symmetry variant of the hexagonal unit cell. For example, the solid crystalline material may be described by an orthorhombic unit cell. In some embodiments the solid crystalline material may be described by a monoclinic unit cell. In some embodiments, the solid crystalline material of the first aspect comprises a hexagonal unit cell.

Suitably the unit cell of the solid crystalline material comprises alternating layers of tetrahedral species of formula (II): A_{d}DY₄ and species of formula (III): AₑX_{y} in an a-b-a-c stacking sequence, to provide the material of formula (I); wherein A, D, Y and X are as defined above and wherein d and e are each from 1 to 7 and d + e ≤ z; wherein y is from 1 to 3 and y ≤ x. Suitably the tetrahedral species of formula (II) and the species of formula (III) are ionic. Suitably solid crystalline material comprises a hexagonal and/or orthorhombic unit cell having the alternating layers of tetrahedral species of formula (II): A_{d}DY₄ and species of formula (III): AₑX_{y} in an a-b-a-c stacking sequence, as described above.

The solid crystalline material may also be defined by a space group which represents the symmetry of the material. The solid crystalline material of this first aspect suitably has a space group selected from P6₃mc, Pna2₁, P6₃, Pca2₁ and P31c, suitably including space groups which are sub-groups of these space groups. These space groups suitably further describe and are variants of the crystal structure defined above having the hexagonal unit cell with species (II) and (III) in the a-b-a-c stacking sequence. Suitably the solid crystalline material has a space group of Pna2₁. Suitably the solid crystalline material has an orthorhombic unit cell with a Pna2₁ space group comprising species (II) and (III) in the a-b-a-c stacking sequence described above.

In embodiments wherein the crystal structure of the solid crystalline material has a space-group with hexagonal cells - P6₃mc, P6₃ and P31c - the unit cell dimensions may be in the following ranges and may have the following angles:
aₕ = bₕ and is from 6 to 7.5 Angstroms, cₕ is from 9.5 to 12.5 Angstroms, α = β = 90°, γ = 120°
where the subscript h represents the cell lengths for the hexagonal cell.

In embodiments wherein the crystal structure of the solid crystalline material has the space-group Pca2₁ or Pna2₁, the orthorhombic expansion of the hexagonal unit cell is such that:

$${\text{a}}_{\text{o}} = \text{sqrt} \left(3\right) * {\text{a}}_{\text{h}} , {\text{b}}_{\text{o}} = {\text{a}}_{\text{h}} , {\text{c}}_{\text{o}} = {\text{c}}_{\text{h}}$$

where the subscript o represents the cell lengths for the orthorhombic cell. This means that the orthorhombic unit cells have dimensions which are suitably in the following ranges and may have the following angles:

aₒ is from 10.4 to 12.1 Angstroms, bₒ is from 6 to 7.5 Angstroms, cₒ is from 9.5 to 12.5 Angstroms, α = β = γ = 90°.

Suitably the structure may also be described as a derivative of the inverse hexagonal perovskite structure, and therefore structurally related to the lithium antiperovskites Li₃OCl₁₋ₓBrₓ which are good conductors of lithium ions. Suitably the solid crystalline material may be described as a defect hexagonal antiperovskite. Alternatively, the solid crystalline material may be described as having a hexagonal argyrodite crystal structure.

The details of the crystal structure of the solid crystalline material of this first aspect are discussed further below in relation to Example 1 and the Figures.

For the avoidance of doubt, the species mentioned above (Li, Na, K and Mg; Si, Al, P, B, Ga, Ge, S, Mo, W, V, Sn, Sb, Nb and Ta; O, S, F, Cl, Br, I and BH₄) suitably have their normal charges in the solid crystalline material of this first aspect, for example Li⁺, Si⁴⁺, O²⁻, Cl⁻. Suitably the solid crystalline material is overall charge neutral and the formula (I) is charge balanced to provide such a charge neutral material.

The inventors have surprisingly found that these solid crystalline materials of the first aspect may have high conductivity required of a solid-state ionic conductor whilst also having mechanical properties (such as bulk modulus and shear modulus) which facilitate processing and manufacture. These solid crystalline materials may therefore be advantageous for use as solid-state electrolytes in batteries.

The selection of the above “D” atoms accounts for the similar structural chemistries of the proposed cations, from the point of view of both complete substitution (i.e. full replacement of Si for P) or partial substitution (i.e. doping through Si_{1-g}P_{g}). Several of the proposed tetrahedral units DY₄ are known in the crystal structures of existing materials. The size and formal charge of the listed D cations mean that tetrahedral geometries through coordination with the anions Y (O, S, F, Cl or Br) are favourable, and such tetrahedral units are commonplace throughout solid-state chemistry, with many examples in ionic conductor frameworks, e.g. NASICON.

Partial replacement or combinations of multiple D cations in DY₄ are within the scope of formula (I) and are possible through substitutional chemistry, e.g. Al_{1-g}Si_{g}O₄. This substitution can be used to tune the overall composition A_{z}DY₄Xₓ through charge neutrality. Non-stoichiometric combinations of Y are also possible and further extends the options for DY₄. For example, mixed-anion tetrahedral units such as [PO₃F]²⁻, [PO₃S]³⁻, [AlO₃F]⁴⁻, [BO₂F₂]³⁻ and [SO₃F]⁻ are known and may be used herein.

The above listed combinations of DY₄ leading to overall formula A_{z}DY₄Xₓ described in the first aspect are experimentally accessible and their production would utilise synthetic routes similar to, or derivatives of, that described in the third aspect for Li₆SiO₄Cl₂. Suitably the method would entail admixing of sources of A, D, Y and X, and heating the mixture to similar temperatures as described in the third aspect. In the case of multiple D cations with a single Y anion, suitably the synthesis would use multiple sources of DY_{w} in the form of an oxide or sulphide (e.g. SiO₂ and Al₂O₃, or SiS₂ and Al₂S₃).

In some embodiments of the solid crystalline material of formula (I): A_{z}DY₄Xₓ;
each A is independently selected from Li, Na, K and Mg, or a mixture thereof;
D is selected from Si, Al, and P or a mixture thereof;
each Y is independently selected from O and S, or a mixture thereof;
each X is independently selected from F, Cl, Br, I and BH₄, or a mixture thereof;
z is from 2 to 8; and
x is from 1 to 3.

The solid crystalline materials of this first aspect comprises A, wherein each A is independently selected from Li, Na, K and Mg. Therefore the solid crystalline material may comprise one or more of Li, Na, K and Mg.

In embodiments wherein A is Mg, z is suitably 2 to 4.

Suitably each A is independently selected from Li, Na or K. Suitably A is Li.

Suitably the solid crystalline material is of formula (IV): Li_{z}DY₄Xₓ wherein:
D is selected from Si, Al, P, B, Ga, Ge, S, Mo, W, V, Sn, Sb, Nb and Ta, or a mixture thereof;
each Y is independently selected from O, S, F, Cl, Br or a mixture thereof;
each X is independently selected from F, Cl, Br, I, O, S, BH₄ or a mixture thereof;
z is from 2 to 8; and
x is from 1 to 3.

Suitably the solid crystalline material is of formula (IV): Li_{z}DY₄Xₓ wherein:
D is selected from Si, Al, and P;
each Y is independently selected from O and S;
each X is independently selected from F, Cl, Br, I and BH₄;
z is from 2 to 8; and
x is from 1 to 3.

The solid crystalline material of formula (IV) may be described as a lithium hexagonal argyrodite or a defect lithium hexagonal antiperovskite.

The solid crystalline material of formula (I) of this first aspect comprises DY₄. Suitably the DY₄ is a covalently bound unit or compound in the solid crystalline material, wherein the Y atoms are covalently bound to the D atom. Suitably DY₄ is a tetrahedral compound. Suitably DY₄ is an ionic compound (i.e. is charged), suitably a negatively charged ionic compound.

D is selected from Si, Al, P, B, Ga, Ge, S, Mo, W, V, Sn, Sb, Nb and Ta, or a mixture thereof, and each Y is independently selected from O, S, F, Cl, Br or a mixture thereof.

In some embodiments D is selected from Si, Al, and P and each Y is independently selected from O and S. Therefore DY₄ may be selected from SiO₄, AlO₄, PO₄, SiS₄, AlS₄ and PS₄. In some embodiments the crystalline material comprises a mixture of different DY₄ compounds selected from the above options. Suitably all the DY₄ compounds in the solid crystalline material are the same and are selected from the options given above.

The DY₄ species within the solid crystalline material are charged. The SiY₄ tetrahedra have a 4- charge and therefore can be represented by the formula SiY₄⁴⁻; the AlY₄ tetrahedra have a 5- charge and therefore can be represented by the formula AlY₄⁵⁻; and the PY₄ tetrahedra have a 3- charge and therefore can be represented by the formula PY₄³⁻.

Suitably z and x in formulas (I) and (II) are varied in respect of the charge of the DY₄ compound in order to provide an overall charge neutral formula for the material.

Therefore in embodiments wherein each A is selected from Li⁺, Na⁺ and K⁺ and the DY₄ compound is SiY₄⁴⁻, wherein Y is selected from O and S or a mixture thereof, z is suitably equal to 4 + x, wherein x is from 1 to 3. Therefore z is suitably from 5 to 7, when dependent on x in this way.

In embodiments wherein each A is selected from Li⁺, Na⁺ and K⁺ and the DY₄ compound is AlY₄⁵⁻, wherein Y is selected from O and S or a mixture thereof, z is suitably equal to 5 + x, wherein x is from 1 to 3. Therefore z is suitably from 6 to 8, when dependent on x in this way.

In embodiments wherein each A is selected from Li⁺, Na⁺ and K⁺ and the DY₄ compound is PY₄³⁻, wherein Y is selected from O and S or a mixture thereof, z is suitably equal to 3 + x, wherein x is from 1 to 3. Therefore z is suitably from 4 to 6, when dependent on x in this way.

In some embodiments the DY₄ species comprises from 2 to 4 O or S atoms and from 0 to 2 F, Cl or Br atoms. For example the DY₄ species may be [PO₃F]²⁻ or [PO₃S]³⁻.

In such embodiments wherein at least one of the Y atoms is F, Cl or Br, DY₄ will accordingly have a lower negative charge. For example the DY₄ species may be [PO₃F]²⁻ and therefore z is suitably equal to 2 + x, wherein x is from 1 to 3.

In preferred embodiments the DY₄ compound of the solid crystalline material is SiO₄⁴⁻. Therefore the solid crystalline material suitably has the formula (V): A_{z}SiO₄Xₓ; wherein each A is independently selected from Li⁺, Na⁺ and K⁺ or mixtures thereof, each X is independently selected from F⁻, Cl⁻, Br⁻, I⁻ and BH₄⁻ or mixtures thereof and z is equal to 4 + x, wherein x is from 1 to 3.

In especially preferred embodiments, A is Li⁺ and the DY₄ compound is SiO₄⁴⁻. Therefore the solid crystalline material suitably has the formula (VI): Li_{z}SiO₄Xₓ; wherein each X is independently selected from F⁻, Cl⁻, Br⁻, I⁻ and BH₄⁻ or mixtures thereof and z is equal to 4 + x, wherein x is from 1 to 3. In such embodiments, x is suitably 2 and therefore z is suitably 6.

In such embodiments, suitably each X is independently selected from Cl or Br.

In such embodiments, the solid crystalline material has the formula Li₆SiO₄Cl₂₋ᵥBrᵥ; wherein v is from 0 to 2. Suitably v is from 0 to 1.

In one embodiment v is 0 and the solid crystalline material has the formula Li₆SiO₄Cl₂.

In one embodiment v is 1 and the solid crystalline material has the formula Li₆SiO₄BrCl.

Suitably the solid crystalline material of this first aspect is Li₆SiO₄Cl₂ or Li₆SiO₄BrCl having a defect hexagonal antiperovskite (or hexagonal argyrodite) crystal structure.

According to a second aspect of the present invention, there is provided a solid crystalline material having a hexagonal unit cell or an orthorhombic unit cell comprising alternating layers of tetrahedral species of formula (II): A_{d}DY₄ and species of formula (III): AₑX_{y} in an a-b-a-c stacking sequence; wherein:
each A is independently selected from Li, Na, K and Mg;
D is selected from Si, Al, P, B, Ga, Ge, S, Mo, W, V, Sn, Sb, Nb and Ta, or a mixture thereof;
each Y is independently selected from O, S, F, Cl, Br or a mixture thereof;
each X is independently selected from F, Cl, Br, I, O, S, BH₄ or a mixture thereof;
d and e are each from 1 to 7; and
y is from 1 to 3.
Suitably d + e = from 2 to 8.

The solid crystalline material of this second aspect may have any of the suitable features and advantages described in relation to the first aspect.

According to a third aspect of the present invention, there is provided a solid conductive material comprising a solid crystalline material according to the first or second aspects.

According to a fourth aspect of the present invention, there is provided a mixed solid crystalline material comprising a first solid material of formula (I) according to the first aspect or the second aspect and a second solid material. The combination of the first and second solid materials in the mixed solid crystalline material of this fourth aspect may provide a solid conductive material which has advantageous properties compared to the first solid material alone as described in relation to the first aspect.

Suitably the mixed solid crystalline material is a solid solution of the first and second solid materials. Therefore the first and second solid materials are homogenously mixed together in the mixed solid crystalline material of this fourth aspect, i.e. the first and second solid materials are not present in separate phases of different compositions and/or different crystal structures. Suitably the mixed solid crystalline material of this fourth aspect has a single crystal structure which comprises both the first and second solid materials. Suitably the mixed solid crystalline material has a crystal structure comprising hexagonal and cubic stacking.

The first solid material has the formula (I): A_{z}DY₄Xₓ as described in relation to the first aspect. The first solid material may be present in the mixed solid crystalline material as layers of tetrahedral species of formula (II): A_{d}DY₄ and species of formula (III): AₑX_{y} as described in relation to the first aspect.

In some embodiments, the second solid material may also be according to the first or second aspect which is different to the first solid material. In such embodiments, the second solid material suitably has the formula (I): A_{z}DY₄Xₓ as described in relation to the first aspect and is different to the first solid material, i.e. the second solid material has a composition within the definition of formula (I) but which is different to the composition of the first solid material.

In such embodiments, the mixed solid crystalline material may have a crystal structure having an hexagonal and/or orthorhombic unit cell comprising alternating layers of tetrahedral species of formula (II): A_{d}DY₄ and species of formula (III): AₑX_{y} in an a-b-a-c stacking sequence, as described in relation to the first or second aspect, wherein the species of formula (II) and formula (III) are mixtures of those species from the first and second solid materials.

Alternatively, in such embodiments wherein the second solid material has the formula (I): A_{z}DY₄Xₓ as described in relation to the first aspect, the mixed solid crystalline material may have a crystal structure which has features of the crystal structure described in relation to the first aspect as well as features of a second, different, crystal structure. For example the features of the second crystal structure may be features of a cubic argyrodite crystal structure. Suitably in such embodiments the mixed solid crystalline material has a crystal structure which is a hybrid of the cubic argyrodite crystal structure and the hexagonal argyrodite crystal structure described in relation to the first aspect. The crystal structure of the mixed solid crystalline material may comprise both cubic and hexagonal stacking, as described above in relation to the first aspect. In such embodiments, the combination of the first solid material and the second solid material alters the ratio of cubic and hexagonal stacking compared to the first solid material alone. The features of the cubic argyrodite crystal structure are suitably derived from a crystal structure of a solid material of formula (I): A_{z}DY₄Xₓ having a cubic unit cell comprising alternating layers of tetrahedral species of formula (II): A_{d}DY₄ and species of formula (III): AₑX_{y} in an a-b-c stacking sequence (with the composition definitions given above in relation to the first aspect).

Such a different crystal structure may be obtained by using a different synthetic procedure to prepare the mixed solid crystalline material compared to the solid crystalline material of the first aspect.

In some embodiments of the mixed solid crystalline material of this fourth aspect, the second solid material has a different chemical composition to the first solid material which does not confirm to the formula (I). For example, in such embodiments, the second solid material suitably has a formula Li₃OX, wherein X is selected from F, Cl, Br, I, BH₄, S, Se or a mixture thereof. Such materials, when provided as a single solid crystalline material, suitably have an anti-perovskite crystal structure. The compositions of these second solid crystalline materials would not be distinguishable from cubic argyrodites, but their structures and properties within the mixed solid crystalline material would be.

Suitably in such embodiments the mixed solid crystalline material has a crystal structure which is a hybrid of the hexagonal argyrodite crystal structure described in relation to the first aspect and a second crystal structure, such as a cubic argyrodite crystal structure or an anti-perovskite crystal structure.

For example, the crystal structures of these mixed solid crystalline materials may have layers with different stacking arrangements to the a-b-a-c arrangement of the solid crystalline materials of the first aspect (such as Li₆SiO₄Cl₂) or the a-b-c arrangement of Li₆PO₅Cl and Li₃OCl. In the normal perovskites, arrangements such as a-b-c-a-c-b and a-c-b-c-b are known and could reasonably be expected to be accessible in these anti-perovskite analogues, along with other arrangements observed in normal perovskites.

In these alternative embodiments, the different stackings in the crystal structure of these first and second solid materials will produce different chemical environments and different conduction pathways for the mobile A cations, and, very importantly, different defect chemistries (leading to Li vacancies and interstitials which transport the charge) in addition to the substitutions we discuss above. These could provide materials with improved properties for applications in solid state batteries.

The mixed solid crystalline material of this fourth aspect may comprise one or more additional solid materials, as well as the first and second solid materials. Therefore the mixed solid crystalline material of this fourth aspect may comprise a third and/or fourth and/or fifth solid material.

According to a fifth aspect of the present invention, there is provided a solid-state battery comprising:
an anode;
a cathode; and
an electrolyte comprising a solid crystalline material as described in relation to the first aspect.

In embodiments wherein A is Li, the solid crystalline material is suitably a solid-state lithium ion conductor.

Suitably the electrolyte is arranged between the cathode and an anode. Suitably the electrolyte is a solid-state electrolyte. Suitably the solid-state battery is a rechargeable (or “secondary” battery).

Suitable materials for the cathode and anode may be known in the art.

The cathode is suitably a lithium host material capable of storing and releasing lithium ions. For example, the cathode may be a lithium metal oxide wherein the metal is one or more of aluminium, cobalt, iron, manganese, nickel and vanadium. Example lithium metal oxides are LiCoO₂ (LCO), LiFeO₂, LiMnO₂ (LMO), LiMn₂O₄, LiNiO₂ (LNO), LiNiₓCo_{y}O₂, LiMnₓCo_{y} O₂, LiMnₓNi_{y}O₂, LiMnₓNi_{y}O₄, and LiNiₓCo_{y}Al_{z}O₂ amongst others.

Further examples of cathode materials are lithium-containing phosphates having a general formula LiMPO₄ wherein M is one or more of cobalt, iron, manganese, and nickel, such as lithium iron phosphate (LFP) and lithium iron fluorophosphates. Many different elements, e.g., Co, Mn, Ni, Cr, Al, or Li, may be substituted or additionally added into the structure to influence electronic conductivity, ordering of the layer and cycling performance of the cathode materials. The cathode active material can be a mixture of any number of these cathode materials.

Suitable materials for the anode are a lithium host material capable of incorporating and subsequently releasing the lithium ion such as graphite, a lithium metal oxide (e.g., lithium titanium oxide), carbon, a tin/cobalt alloy or silicon/carbon composite material. The anode material can be a mixture of any number of these anode materials. Alternatively, pure Li metal may provide the anode.

According to a sixth aspect of the present invention, there is provided a method of preparing a solid crystalline material according to the first or second aspects, the method comprising the steps of:
(a) admixing a source of A and a source of DY_{w}, wherein w is from 1 to 3, to form a precursor comprising A, D and Y;
(b) admixing the precursor obtained in step (a) with a source of AX;
(c) heating the mixture obtained in step (b).

The method may be a solid state (or dry) procedure, i.e. not requiring a solvent.

The solid crystalline material prepared by this sixth aspect may have any of the suitable features and advantages described above in relation to the first aspect.

The solid crystalline material prepared by this sixth aspect may be used in the solid-state battery of the fifth aspect.

Suitably the steps of the method of this sixth aspect are carried out in the order of step (a) followed by step (b) followed by step (c).

Step (a) involves admixing a source of A and a source of DY_{w} to form a precursor comprising A, D and Y. The source of A may be any suitable material comprising Li, Na, K or Mg. Suitably the source of A is a carbonate or oxide of Li, Na, K or Mg.

The source of DY_{w} is suitably a sulfide or an oxide. Suitably the source of DY_{w} is a silicon oxide, an aluminium oxide, a phosphorus oxide, a silicon sulfide, an aluminium sulfide and/or a phosphorus sulfide. In embodiments wherein D is phosphorus, the source of DY_{w} is suitably NH₄H₂PO₄ which is advantageously easier to handle than the hygroscopic P₂O₅.

The method of this sixth aspect may be a solution based synthetic procedure. In such embodiments, suitable sources of DY_{w} may be aluminium nitrate, aluminium hydroxide, tetraethyl orthosilicate (TEOS), phosphoric acid and aluminium isopropoxide.

The source of A and the source of DY_{w} are admixed in step (a). Suitably the source of A and the source of DY_{w} are mixed together in a ratio of from 4:1 to 1:1, suitably from 3:1 to 1:1.

In embodiments wherein the solid crystalline material produced by the method comprises SiO₄, the source of DY_{w} is suitably SiO₂.

In such embodiments, the source of A and the SiO₂ are mixed together in a ratio of from 3:1 to 1:1, suitably in a ratio of approximately 2:1, particularly wherein A is selected from Li, Na or K (and therefore having a 1+ charge).

Suitably the source of A and the source of DY_{w} are provided as powders. Suitably in step (a) the source of A and the source of DY_{w} are ground together and heated.

Suitably step (a) involves heating the source of A and the source of DY_{w} to a temperature of from 300 to 1,000° C., suitably from 600 to 900° C.

Suitably step (a) involves heating the source of A and the source of DY_{w} for up to 5 hours, for example up to 10 hours or up to 15 hours. For example the source of A and the source of DY_{w} may be heated in air to 800° C. at a ramp rate of 5° C./min, held at 800° C. for 12 hours and cooled at a ramp rate of 5° C./min.

Step (a) provides a precursor comprising A, D and Y. Suitably the precursor is a compound of A, D and Y, suitably having the formula (V): AₕDY₄, wherein h is from 1.5 to 5, suitably wherein the value of h is dependent on the charge of the DY₄ ionic compound, as discussed above.

In embodiments wherein the solid crystalline material produced by the method comprises SiO₄, the precursor comprising A, D and Y is suitably AₕSiO₄, wherein h is from 2 to 4 and suitably wherein A is selected from Li, Na, K or Mg. For example, the precursor comprising A, D and Y may be Li₄SiO₄.

Step (b) of the method of the third aspect involves admixing the precursor obtained in step (a) with a source of AX.

The “A” atom referred to in step (b) may be the same or different to the “A” atom referred to in step (a).

Suitably the source of AX is an ionic salt of Li, Na, K or Mg, suitably comprising one or more of F, Cl, Br, I, O, S and BH₄. Therefore the source of AX may be selected from LiF, LiCl, LiBr, LiI, Li₂O, Li₂S, LiBH₄, NaF, NaCl, NaBr, Nal, Na₂O, Na₂S, NaBH₄, KF, KCl, KBr, Kl, K₂O, K₂S, KBH₄, MgF₂, MgCl₂, MgBr₂, MgI₂, MgO, MgS, MgBH₄ and mixtures thereof.

In some embodiments, the source of AX is LiCl or LiBr, or a mixture thereof.

Suitably the source of AX is a powder. Suitably the precursor obtained in step (a) is a powder. Suitably in step (b) the source of AX and the precursor obtained in step (a) are powders and are ground together.

Suitably in step (b) the source of AX and the precursor obtained in step (a) are mixed together in a ratio of from 4:1 to 1:1, suitably from 3:1 to 1:1.

In embodiments wherein the solid crystalline material produced by the method comprises SiO₄ and the precursor obtained in step (a) is suitably AₕSiO₄ (for example Li₄SiO₄), the source of AX and the AₕSiO₄ are mixed together in a ratio of from 3:1 to 1:1, suitably in a ratio of approximately 2:1, particularly wherein A is selected from Li, Na or K (and therefore having a 1+ charge).

Step (c) involves heating the mixture obtained in step (b). Suitably step (c) involves heating the precursor obtained in step (a) with the source of AX to a temperature of from 300 to 1000° C., suitably from 400 to 600° C.

In embodiments wherein the solid crystalline material produced by the method is of formula Li₆SiO₄Cl₂-ᵥBrᵥ wherein v is from 0 to 2, the source of A is suitably Li₂CO₃, the source of DY_{w} is suitably SiO₂; the precursor is suitably Li₄SiO₄ and the source of AX is suitably LiCl, LiBr or a mixture thereof.

According to a seventh aspect of the present invention, there is provided the use of a solid crystalline material according to the first aspect as a solid-state conductor.

In embodiments wherein A comprises Li, the solid crystalline material may be used as a lithium ion electrolyte in primary and secondary electrochemical energy stores.

In this seventh aspect, the solid crystalline material is suitably used as a solid electrolyte, for example in a solid-state lithium-ion battery.

The solid crystalline material used in this seventh aspect may have any of the suitable features and advantages described in relation to the first aspect. For example, the solid crystalline material used in this seventh aspect may provide high electrical conductivity whilst also having mechanical properties (such as bulk modulus and shear modulus) which facilitate processing and manufacture. The use of such solid crystalline materials of the first aspect may therefore provide an advantageous solid-state conductor for use as a solid-state electrolyte in batteries.

### EXAMPLES

### Computational Methods

In the examples below, density functional theory (DFT) calculations were performed using the periodic plane-wave based VASP code (version 5.4.4). All calculations were performed with the projector augmented wave method, a plane-wave cut-off energy of 700 eV and a k-point spacing of 0.15 Å⁻¹. Atomic positions and unit cell parameters were optimised until all forces fell below 0.001 eVÅ⁻¹. The PBE (Perdew-Burke-Ernzerhof) functional was used to calculate relative energies, and the PBEsol functional used for direct comparison between computational and experimental crystal structures. Normal mode calculations were performed using the harmonic approximation, with finite displacements of 0.01 Å and including distortions of the unit cell. This allowed the calculation of elastic constants, including the bulk and shear modulus.

### Example 1: Li₆SiO₄Cl₂

### Materials

Li₂CO₃ (99.99%), SiO₂ (silica gel, technical grade, particle size 40-63 µm) and LiCI (> 99.0%) were purchased from Sigma Aldrich.

### Synthesis of Li₄SiO₄

Precursors were dried overnight in a 200° C. furnace before use. Li₂CO₃ (1.2331 g) and SiO₂ (0.5013 g) were weighed according to the stoichiometric 2:1 ratio. The powders were ground in an agate mortar for 15 minutes, placed into an alumina crucible and heated in air to 800° C. at a ramp rate of 5° C./min, held at 800° C. for 12 hours and cooled at a ramp rate of 5° C./min. The resulting powder was ground in an agate mortar to obtain a fine powder, which was then used as a precursor in the final synthesis step.

### Synthesis of Li₆SiO₄Cl₂

Li₄SiO₄ and LiCl were vacuum dried overnight (left under 10⁻⁴ mbar) before placing them in an Ar-filled glove box. All precursors and resulting powders were then handled in an Ar-filled glove box. LiCl (0.4143 g) and Li₄SiO₄ (0.5857 g) were mixed in the stoichiometric 2:1 ratio, ground in an agate mortar for 15 min and transferred to an alumina crucible. The crucible was placed in a quartz tube before sealing under vacuum (10⁻⁴ mbar). The tube was heated to 550° C. at a ramp rate 5° C./min, held at 550° C. for 12h and cooled at a rate of 5° C./min. The quartz tube was opened inside the Ar glovebox, and the powder ground in a pestle and mortar for further characterisation.

### Powder X-Ray Diffraction

Laboratory powder X-ray diffraction (PXRD) patterns contained reflections which could not be indexed to any previously reported phases. Analysis of these PXRD patterns also showed that they were not consistent with the F43m argyrodite structure, or any of the lower symmetry derivatives. Instead, indexing the laboratory PXRD pattern of Li₆SiO₄Cl₂ suggested a hexagonal lattice with a cell of approximate dimensions a = b = 6.1 Å, c = 10.0 Å. The relationship of the argyrodite to the inverse cubic perovskite structure suggested that the structure of the new compounds might be related to the inverse hexagonal perovskites.

A structure was therefore built in the P6₃mc spacegroup as an inverse hexagonal perovskite in which half of the A-sites were occupied with silicate polyanions and half with chloride anions. Half of the B-sites were then occupied by the remaining chloride anions, with the vacant B-sites chosen to avoid interactions between the chloride anions and the corners of the silicate tetrahedra.

Optimisation of this P6₃mc structure with DFT resulted in a structure which gave a reasonable match to laboratory PXRD data, however normal mode calculations showed that this structure was unstable to displacements of the lithium atoms off the mirror planes in the P6₃mc structure, leading to lower symmetry structures. The lowest energy (most stable) structure in spacegroup Pna2₁was calculated to be 16 meV/atom more stable than the conventional argyrodite structure, as shown in FIG. 3.

This proved to be a good starting point to Rietveld refinement of synchrotron PXRD data of the Li₆SiO₄Cl₂ compound.

### Variable Temperature X-Ray Diffraction

Synchrotron variable temperature X-ray diffraction (VT-XRD) was performed at Diamond Light Source UK, on high-resolution beamline l11, at λ = 0.82660 Å. The pattern was recorded in transmission mode [0° <2 θ < 150°] using a position sensitive detector (PSD) on a sample which was introduced into a 1.0 mm diameter quartz capillary. The experiment was performed in the temperature range 25-550° C. (25° C. steps on heating, then cooled down to room temperature to check for reversibility).

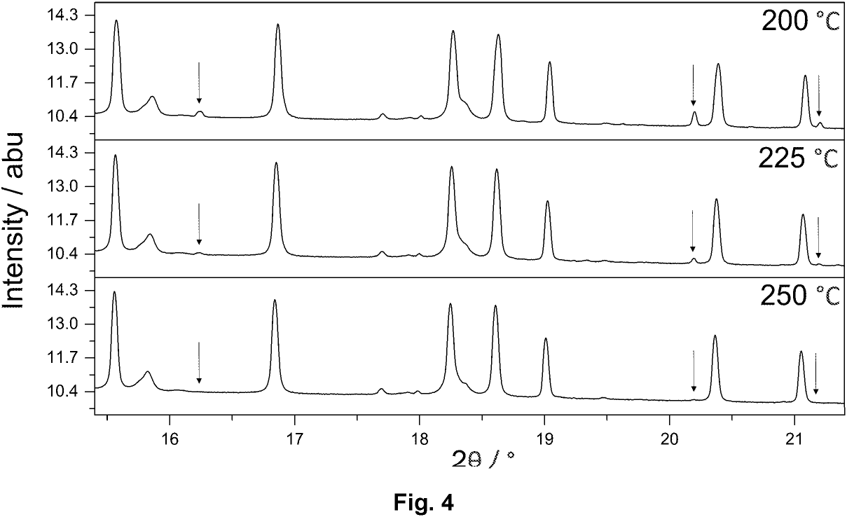

The VT-XRD patterns show some peaks disappearing at about 200-250° C. (FIG. 4); the peaks which disappear are all orthorhombic peaks indicating the transition from an orthorhombic to a higher symmetry hexagonal space group. FIG. 4 shows the VT-XRD patterns (200, 225 and 250° C.), black arrows highlight disappearing of orthorhombic peaks.

### Discussion of Crystal Structure

As will be known by the skilled person, solid crystalline materials may be described in terms of close-packed lattices. Such close-packed lattices can be broken down into layers that are related by specific stacking rules. Therefore a family of solid crystalline materials may be described by a specific stacking sequence of layers with specific atomic arrangements that is unique to that family.

Solid crystalline materials may be described with reference to the close-packing of spheres (suitably atoms). Translation of a given layer a by in-plane translations of (⅓, ⅔) and (⅔, ⅓) respectively along the hexagonal cell vectors results in layers b and c. The a, b and c layers can then be stacked in the out-of-plane direction in any order, as long as no layer is directly stacked upon itself. For example, the sequence a-b-c-a-b-c results in face-centered cubic (fcc) lattices and the sequence is a-b-a-b results in hexagonal close-packed (hcp) lattices.

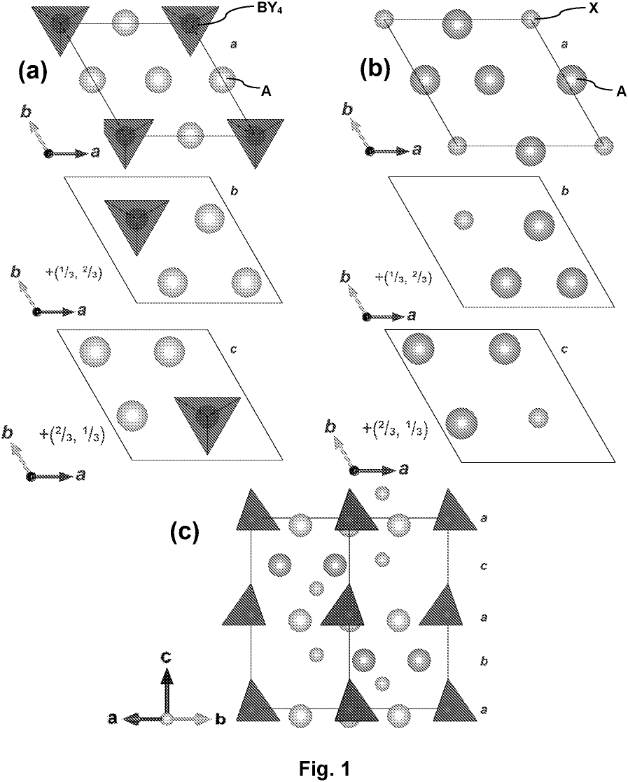

The solid crystalline material of the present invention, as exemplified by Example 1, suitably comprises alternating layers of formula A_{b}DY₄ and layers of formula A_{c}X_{y}in an a-b-a-c stacking sequence, as shown in FIG. 1. FIG. 1 (a) shows A_{b}DY₄ layers, FIG. 1 (b) shows A_{c}X_{y} layers and FIG. 1 (c) shows the a-b-a-c stacking.

Suitably, once the layers are stacked, smaller anions occupy the octahedral interstitial sites in between every other pair of layers. These can be seen in FIG. 1 (c).

Suitably the solid crystalline material may be described as an inverse perovskite or an antiperovskite structure. The antiperovskite crystal structure is similar to the normal perovskite structure ABX₃ but cations occupy sites usually occupied by anions and vice versa.

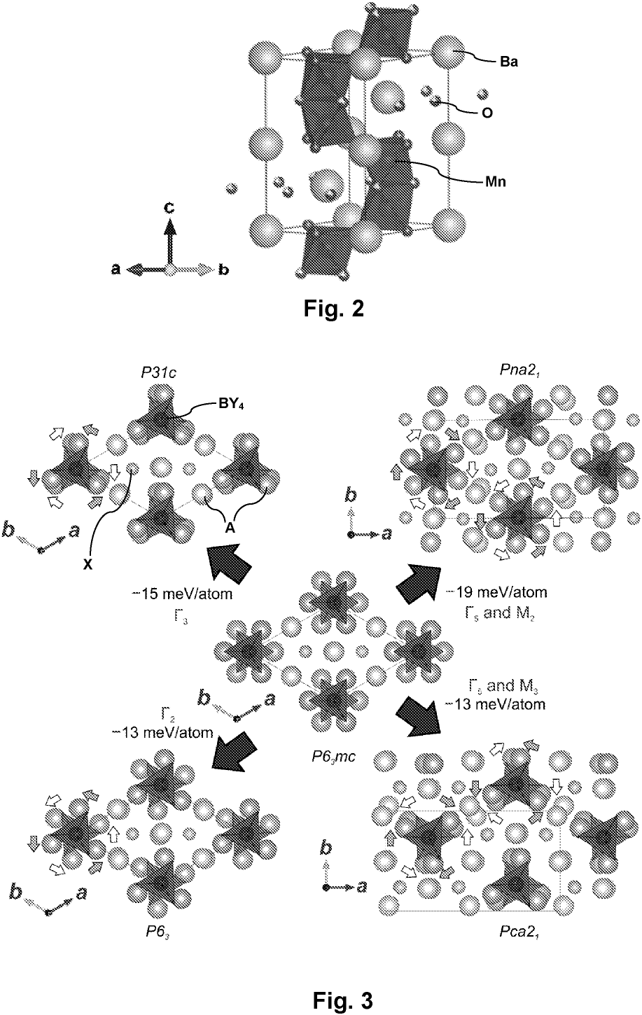

Suitably this solid crystalline material may be described in relation to a conventional hexagonal perovskite structure, for example 4H-BaMnO₃ shown in FIG. 2. Suitably in the materials of the present invention the oxide anions in 4H-BaMnO₃ are replaced by A cations, the Ba cations are replaced by a mixture of DY₄ polyanions and X anions, and half of the Mn cations are replaced with X anions. Suitably half of the sites usually occupied by Mn cations are vacant in the materials of the present invention.

Suitably the vacant sites avoid interactions between the X anions and the corners of the DY₄ tetrahedra.

In some embodiments the solid crystalline material of the present invention may be described by the P6₃mc space group.

In other embodiments the material may comprise displaced A cations. In such embodiments the A cations may be displaced off the mirror planes. These displacements are ordinarily less than 1 Angstrom, and can be described as rotations of three A cations around the axis passing through the DY₄ polyanions. Examples of such displacements are demonstrated in FIG. 3.

Suitably the solid crystalline material may also be described by a lower symmetry space group as a result of the displacement, for example Pna2₁, P6₃, Pca2₁ and P31c, suitably including space groups which are sub-groups of these space groups.

### Elastic Constant Calculations

DFT calculations of the elastic constants for Li₆SiO₄Cl₂ in the Pna2₁ structure give a bulk modulus, B = 53 GPa and a shear modulus, G = 31 GPa. These values are close to those of the lithium anti-perovskites (e.g. LisOBr: B = 50.6 GPa, G = 37 GPa) and lie in between those of oxide lithium ion conductors which are too hard to process easily (e.g. Li₇La₃Zr₂O₁₂: B = 117 GPa, G = 64 GPa, and those of sulphide lithium ion conductors which are too soft (e.g. Li₆PS₅Br: B = 27 GPa, G = 14 GPa). This suggests that the lithium hexagonal argyrodites of the present invention would have mechanical properties which would enable straightforward processing into functional devices when compared to other lithium ion conductors.

### AC Impedance Spectroscopy

A pellet of Li₆SiO₄Cl₂ (Example 1) was made by uniaxially pressing ~30 mg of material in an 8 mm cylindrical steel dye at a pressure of 125 MPa. The pellet was sintered in an evacuated, flame dried quartz tube for 12 h at 575° C. Using this method, a relative density of 84% was achieved.

AC impedance measurements were conducted using an impedance analyser (Keysight impedance analyser E4990A). A sputtered gold coating of ~0.3 nm thickness was used as the ion blocking electrodes. Sputtering was achieved using the sputter coater Q150R. Temperature dependent conductivity measurements were performed under argon in a frequency range of 2 MHz - 20 Hz (with an amplitude of 1 mV). Measurements were performed in the temperature range 60 - 300° C. in 20° C. steps. The ZView2 program was used to fit the impedance spectra with an equivalent circuit.

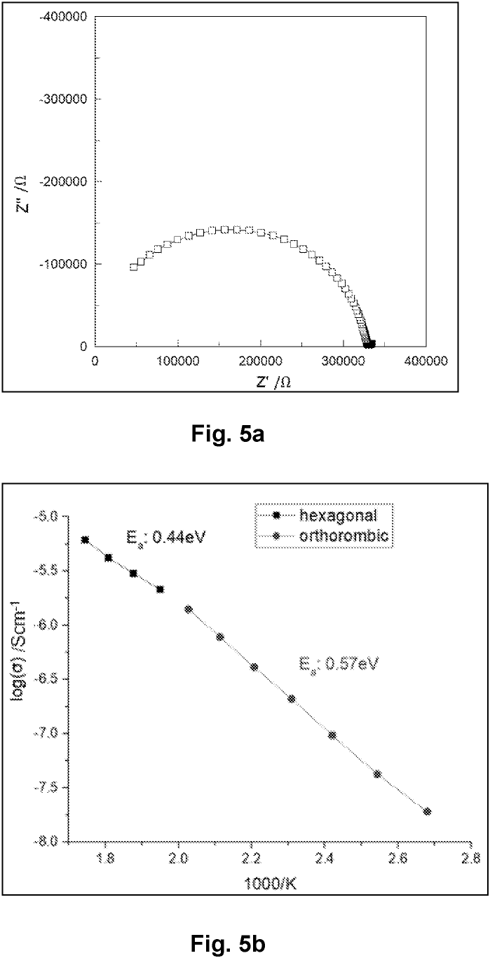

FIG. 5a shows a Nyquist plot at 250° C. of Li₆SiO₄Cl₂. The plot shows one semicircle corresponding to the total impedance of the sample; grain boundary contributions and bulk contribution could not be separated. The capacity values are in the order of ~ 10⁻¹² F which fits well with characteristic bulk response values. The high-frequency intercept of the semicircle gives direct values of the total resistance. The material shows a total ionic conductivity of 6.2 × 10⁻⁶ Scm⁻¹ at 300° C. and ~ 10⁻¹⁰ Scm⁻¹ at room temperature.

FIG. 5b shows the Arrhenius plot of the bulk conductivity of Li₆SiO₄Cl₂ obtained from variable temperature by AC impedance measurements. The impedance of the material was measured over the temperature range 25-300° C. The total conductivity at each temperature was extracted and shown to follow the Arrhenius law. A change in slope in the Arrhenius plot can be seen at ~200° C. agreeing with the change in symmetry observed in the VT-XRD experiments. The two phases were therefore named hexagonal and orthorhombic (as shown) corresponding to the two symmetry settings observed in the VT-XRD pattern. The activation energies for the two phases could be extracted as 0.44 eV for the hexagonal and 0.57 eV for the orthorhombic phase.

These conductivities show that the materials described herein have promising properties for the development of solid-state conductors, especially considering that these results have been obtained with unoptimized and particularly un-doped materials, and considering the predicted favourable physical properties of these materials. The solid crystalline materials of the present invention may therefore be useful as solid electrolytes in solid-state lithium ion batteries.

### Example Set 2: Li₆SiO₄Cl₂₋ᵥBrᵥ

### Materials

Li₂CO₃ (99.99%), SiO₂ (silica gel, >99.0 %), Li₃PO₄ (), Li₂S (), LiCl (> 99.0%) and LiBr (>99.0%) were purchased from Sigma Aldrich. Li₂O (>99.0 %) was purchased from Alfa Aesar.

### Synthesis of Li₄SiO₄

Precursors were dried overnight in a 200° C. furnace before use. Li₂CO₃ (1.2331 g) and SiO₂ (0.5013 g) were weighed according to the stoichiometric 2:1 ratio. The powders were ground in an agate mortar for 15 minutes, placed into an alumina crucible and heated in air to 800° C. at a ramp rate of 5° C./min, held at 800° C. for 12 hours and cooled at a ramp rate of 5° C./min. The resulting powder was ground in an agate mortar to obtain a fine powder, which was then used as a precursor in the final synthesis step.

### Synthesis of Li₆SiO₄Cl₂₋ₓBrₓ

Li₄SiO₄, LiCl and LiBr were dried under vacuum (20 mBar) overnight before moving them to an Ar- filled glove box. The required stoichiometric amounts of Li₄SiO₄, LiCl and LiBr were weighed out and ground in a mortar and pestle for 15 minutes. The relative amounts of LiCl and LiBr were adjusted to prepare Examples 2.1-2.5 with the following values of x in the formula Li₆SiO₄Cl₂₋ₓBrₓ: 2.1 - x = 1, 2.2 - x = 0.75, 2.3 - x = 0.5, 2.4 - x = 0.3, 2.5 - x = 0.1. The resulting mixtures were transferred to aluminium crucibles and placed into quartz tubes which were then evacuated and sealed under vacuum. The evacuated quartz tubes were heated to 500° C. and annealed for 12 h before cooling to room temperature at a heating and cooling rate of 5° C./min).

### Powder X-Ray Diffraction (PXRD)

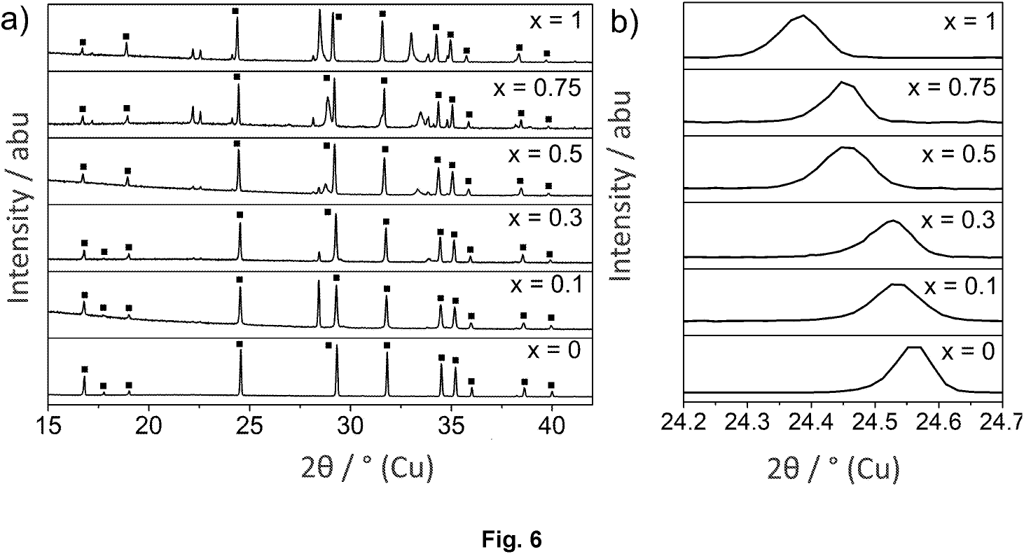

Laboratory X-ray Diffraction (XRD) patterns of Examples 2.1-2.5 showed peaks corresponding to the hexagonal argyrodite phase as adopted by Li₆SiO₄Cl₂ (described in example 1, x = 0) alongside several peaks corresponding to Li₄SiO₄ and LiBr impurities. Close inspection of the hexagonal argyrodite peaks showed a shift in peak position to lower 2θ values with increasing amount of bromine in the sample (FIGS. 6 (a) and (b)). FIG. 6 (a) shows the PXRD patterns for Li₆SiO₄Cl₂₋ₓBrₓ (x = 0, 0.1, 0.3, 0.5, 0.75, 1, x = 0 being Example 1), black squares indicate peaks corresponding to the Li₆SiO₄Cl₂₋ₓBrₓ phase, remaining peaks correspond to Li₄SiO₄ and LiBr impurities. FIG. 6 (b) highlights the peak shift to lower 2 θ values with increasing value of x in Li₆SiO₄Cl₂₋ₓBrₓ.

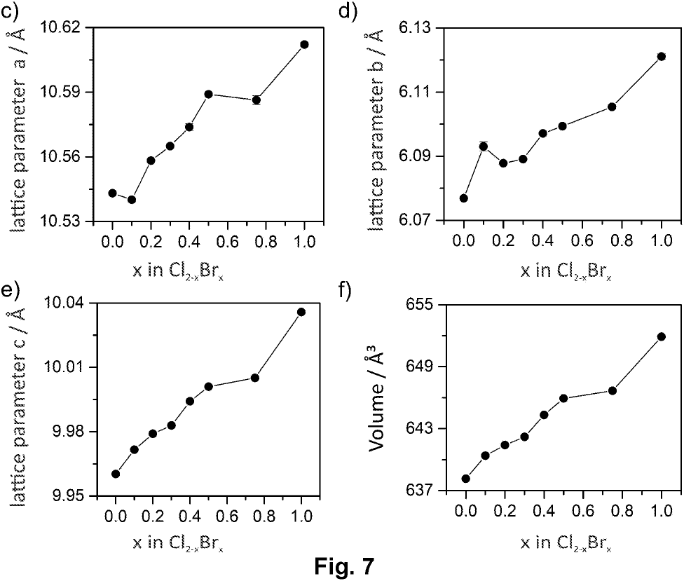

FIGS. 7 (c) and (d) show lattice parameters a and b as a function of x in Li₆SiO₄Cl₂₋ₓBrₓ. FIGS. 7 (e) and (f) show lattice parameter c and unit cell volume as a function of x in Li₆SiO₄Cl₂₋ₓBrₓ. The hexagonal argyrodite phase formed in samples with values of 0 > x > 1. Extraction of the lattice parameters from PXRD patterns shows an increase in lattice parameters with increasing x suggesting the incorporation of bromine into the hexagonal argyrodite phase. Rietveld refinement on the sample with a value of x = 1 shows extra density around the larger A site position suggesting the incorporation of bromine onto this site.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

For the avoidance of doubt, wherein amounts of components in a composition are described in wt%, this means the weight percentage of the specified component in relation to the whole composition referred to.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A solid crystalline material of formula (I): A_{z}DY₄Xₓ wherein:
each A is independently selected from Li, Na, K and Mg;
D is selected from Si, Al, P, B, Ga, Ge, S, Mo, W, V, Sn, Sb, Nb and Ta, or a mixture thereof;
each Y is independently selected from O, S, F, Cl, Br or a mixture thereof;
each X is independently selected from F, Cl, Br, I, O, S, BH₄ or a mixture thereof;
z is from 2 to 8; and
x is from 1 to 3.

2. The solid crystalline material according to claim 1, having a crystal structure comprising a hexagonal unit cell and/or an orthorhombic unit cell.

3. The solid crystalline material according to claim 2, wherein the hexagonal unit cell and/or orthorhombic unit cell comprises alternating layers of tetrahedral species of formula (II): A_{d}DY₄ and species of formula (III): AₑX_{y} in an a-b-a-c stacking sequence, to provide the material of formula (I); wherein d and e are each from 1 to 7 and d + e ≤ a; wherein y is from 1 to 3 and y ≤ x.

4. The solid crystalline material according to claim 1, having a crystal structure with a space group selected from P6₃mc, Pna2₁, P6₃, Pca2₁, P31c.

5. The solid crystalline material according to claim 1, wherein each A is selected from Li, Na or K.

6. The solid crystalline material according to claim 1, wherein D is Si.

7. The solid crystalline material according to claim 1, wherein Y is O.

8. The solid crystalline material according to claim 1, wherein each X is Cl or Br.

9. The solid crystalline material according to claim 1, having the formula Li₆SiO₄Cl₂₋ᵥBrᵥ; wherein v is from 0 to 2.

10. A solid crystalline material having a hexagonal unit cell and/or an orthorhombic unit cell comprising alternating layers of tetrahedral species of formula (II):
A_{d}DY₄ and species of formula (III): AₑX_{y} in an a-b-a-c stacking sequence; wherein:
each A is independently selected from Li, Na, K and Mg;
D is selected from Si, Al, P, B, Ga, Ge, S, Mo, W, V, Sn, Sb, Nb and Ta, or a mixture thereof;
each Y is independently selected from O, S, F, Cl, Br or a mixture thereof;
each X is independently selected from F, Cl, Br, I, O, S, BH₄ or a mixture thereof;
d and e are each from 1 to 7; and
y is from 1 to 3.

11. A mixed solid crystalline material comprising a solid crystalline material according to claim 1.

12. A mixed solid crystalline material comprising a first solid material according to claim 1 and a second solid material.

13. The mixed solid crystalline material according to claim 12, wherein the second solid material has a formula Li₃OX, wherein X is selected from F, Cl, Br, I, BH₄, S and Se or a mixture thereof.

14. The mixed solid crystalline material according to claim 12, wherein the second solid material is a solid material having a different composition to the first solid material, the second solid state material comprising a solid crystalline material of formula (I): A_{z}DY₄Xₓ wherein:
each A is independently selected from Li, Na, K and Mg;
D is selected from Si, Al, P, B, Ga, Ge, S, Mo, W, V, Sn, Sb, Nb and Ta, or a mixture thereof;
each Y is independently selected from O, S, F, Cl, Br or a mixture thereof;
each X is independently selected from F, Cl, Br, I, O, S, BH₄ or a mixture thereof;
z is from 2 to 8; and
x is from 1 to 3.

15. A solid-state battery comprising:
an anode;
a cathode; and
an electrolyte comprising a solid crystalline material according to claim 1.

16. A method of preparing a solid crystalline material according to claim 1, the method comprising the steps of:
(a) admixing a source of A and a source of DY_{w}, wherein w is from 1 to 3, to form a precursor comprising A, D and Y;
(b) admixing the precursor obtained in step (a) with a source of AX;
(c) heating the mixture obtained in step (b).

17. The method according to claim 16, wherein step (a) involves heating the source of A and the source of DY to a temperature of from 300 to 1000° C.

18. The method according to claim 17, wherein step (c) involves heating the precursor obtained in step (a) with the source of AX to a temperature of from 300 to 1000° C.

19. The method according to claim 18, wherein the solid crystalline material is of formula Li₆SiO₄Cl₂₋ᵥBrᵥ; wherein y is from 0 to 2; wherein the source of A is Li₂CO₃, the source of DY_{w} is SiO₂; the precursor is Li₄SiO₄ and the source of AX is LiCl, LiBr or a mixture thereof.

20. (canceled)
